(19) United States
(12) Patent Application Publication
(10) Pub. No.: US 2009/0306250 A1
(43) Pub. Date: Dec. 10, 2009

(54) CONSTRUCTION MATERIAL AND METHOD OF PREPARATION

(76) Inventor: Patricia J. BILLINGS, Leawood, KS (US)

Correspondence Address: HUSCH BLACKWELL SANDERS LLP, 4801 Main Street, Suite 1000, KANSAS CITY, MO, 64112, US

(21) Appl. No.: 12/132,843

(22) Filed: Jun. 4, 2008

(51) Int. Cl. C04B 11/00; C08K 3/10; C04B 24/28

(52) U.S. Cl. 524/5; 524/421

(57) ABSTRACT

A construction material that includes gypsum and a heat fusion catalyst which includes polyvinyl acetate and a polymer, plus a chemical agent for maintaining a stable emulsion of the polyvinyl acetate and polymer. Cement and/or aggregate materials may be added to the gypsum. The material may be prepared by mixing the catalyst with the powder portion, and then either molding it into a building panel or applying it as a coating on a building member.

### CROSS-REFERENCE TO RELATED APPLICATIONS

None.

### FIELD OF THE INVENTION

This invention relates generally to the field of construction materials and more particularly to a construction material that exhibits improved characteristics in the areas of weight, cost, fire resistance, moisture resistance and thermal qualities. The invention is also directed to a method of preparing an improved construction material.

### BACKGROUND OF THE INVENTION

Building materials of various types have been proposed to improve upon conventional drywall panels and concrete panels. For example, U.S. Pat. No. 4,304,704 to Billings discloses a material which includes gypsum, cement, aggregate particles and a polyvinyl acetate catalyst to provide enhanced thermal insulating properties. While this product represents an improvement in some respects over conventional wallboard, it is not wholly without problems. The polyvinyl acetate catalyst requires a colloid in order to be effective. The colloid is no longer commercially available, so this requirement is problematic to the product as a whole. Also, the gypsum is subject to penetration by water which can cause it to lose strength and even break down completely in some circumstances.

U.S. Pat. No. 5,647,180 to Billings et al. discloses a building panel having a similar construction, but provided with a coating that includes an embedded glass fiber mesh intended to enhance the structural integrity. Again, the polyvinyl acetate catalyst requires an expensive chemical colloid for stability and effectiveness. Also, the need for glass fiber reinforcement complicates the structure and adds significantly to the cost and also to the weight.

### SUMMARY OF THE INVENTION

The present invention is directed to a construction material that is improved in a variety of respects compared to the materials that have been available in the past, and to a method of preparing the material in a cost-effective manner. In accordance with the invention, gypsum is mixed with a special catalyst that includes polyvinyl acetate together with a polymer which enhances the effectiveness and functionality of the catalyst. Because the pva and polymer cannot ordinarily be combined in a stable emulsion, the catalyst is subjected to heat fusion and is treated with an added chemical agent that enhances the stability of the emulsion.

The material may be molded into a building panel or used by spraying it, brushing it or otherwise applying it to a building member as a coating. When formed as a panel, the material can be used in many building applications as a substitute for concrete building panels or other construction panels such as wallboard. The panel construction of the present invention is particularly useful in combination with steel framing to provide an overall structure that exhibits improved qualities such as strength, light weight, fire-resistance, moisture resistance, pest resistance and cost advantages.

The gypsum can be either alpha gypsum or lower cost beta gypsum, depending on the end-use application. Cement may be added to the gypsum for use in some applications, and aggregate material can be added if desired.

Other and further objects of the invention, together with the features of novelty appurtenant thereto, will appear in the course of the following description.

### DETAILED DESCRIPTION OF THE PREFERRED EMBODIMENT

In accordance with the present invention, an improved construction material is formulated using gypsum and a catalyst that includes polyvinyl acetate (pva) and an added polymer that enhances the effectiveness of the pva. The most preferred polymers are those that have high moisture resistance and the ability to increase the compressive strength. In order to maintain the pva and polymer in a stable emulsion, the catalyst is subjected to heat fusion and is treated with a chemical agent which, for example, may be boron composition and either a suitable calcium derivative or a magnesium derivative. The magnesium derivative assists in the control of the set time and can be replaced with other chemical agents if desired. In the boron composition and various calcium derivatives can be used to control the compressive strength. The polymer may be of any suitable type that enhances the catalyst function.

The gypsum may be commercially available alpha gypsum or less expensive beta gypsum to reduce the overall cost of the product. While the quantities can vary, it is preferred in most applications for the material to include about two ounces of the catalyst per pound of powdered gypsum.

Cement can be mixed with the gypsum to provide benefits in many applications. Preferably, if cement is used, it is present by weight in an amount equal to the amount of gypsum. The catalyst is mixed in an amount of about two ounces of catalyst per pound of the gypsum-cement mixture.

Aggregate materials can be included in the product whether or not cement is mixed with the gypsum. The aggregate is preferably flyash, sand or perlite, or a combination of flyash and/or sand and/or perlite. The amount of aggregate can vary widely depending upon the desired characteristics of the end product.

The construction material of the present invention may be prepared by mixing the gypsum with the catalyst and pouring or otherwise adding the resulting mixture to a mold. The mold may have a size and shape to mold the mixture into a standard building panel. Once the material has set, it can be moved from the mold and thereafter attached to framing in the same manner as conventional concrete panels or wallboard panels, such as by gluing, screwing, nailing or otherwise attaching the panel to the framing members. The panel of the present invention is particularly well suited for connection to steel framing.

If cement and/or aggregate materials are used, these constituents are mixed with the gypsum, and the resulting mixture is combined with the catalyst and introduced into the mold. The structure that results when the material is used as paneling is one that exhibits enhanced strength, a light weight, improved fire-resistance, improved moisture resistance, pest resistance, and a low cost. For example, when used as a replacement for concrete panels, the material of the present invention has a compressive strength substantially the same as concrete at a significantly lesser weight and cost.

In addition to being applicable to a mold to form molded building panels, the material of the present invention can be painted, sprayed or otherwise applied in liquid form as a coating on a building panel or other building member. Once the material has solidified in the form of a coating of the desired thickness, it provides a low-cost and light weight coating that adds substantially to the strength of the structure and enhances its resistance to fire and moisture penetration.

From the foregoing it will be seen that this invention is one well adapted to attain all ends and objects hereinabove set forth together with the other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth is to be interpreted as illustrative, and not in a limiting sense.

What is claimed is:

1. A construction material comprising gypsum and a heat fusion catalyst, said catalyst including polyvinyl acetate and a polymer combined with the polyvinyl acetate plus a chemical agent effective to maintain the polyvinyl acetate and polymer in a stable combination.

2. A construction material as set forth in claim 1, including a chemical agent for controlling the set time.

3. A construction material as set forth in claim 1, wherein the gypsum comprises alpha gypsum.

4. A construction material as set forth in claim 1, wherein the gypsum comprises beta gypsum.

5. A construction material as set forth in claim 1, wherein said catalyst is present in the amount of approximately two ounces per pound of gypsum.

6. A construction material as set forth in claim 1, including cement present in an amount by weight approximately equal to the gypsum.

7. A construction material as set forth in claim 6, including an aggregate material.

8. A construction material as set forth in claim 7, wherein said aggregate material is selected from the group consisting of flyash, sand and perlite.

9. A construction material as set forth in claim 1, including an aggregate material.

10. A construction material as set forth in claim 9, wherein said aggregate material is selected from the group consisting of flyash, sand and perlite.

11. A method of preparing a construction material, comprising:
mixing together gypsum and a heat fusion catalyst which includes polyvinyl acetate and a polymer together with a chemical agent effective to maintain the polyvinyl acetate and polymer in a stable mixture; and
molding the gypsum and catalyst in a shape for use as a building panel.

12. A method as set forth in claim 11, including the step of mixing cement with the gypsum and catalyst.

13. A method as set forth in claim 11, including the step of mixing an aggregate material with the gypsum and catalyst.

14. A method as set forth in claim 12, wherein said aggregate material is selected from the group consisting of flyash, sand and perlite.

15. A method as set forth in claim 11, wherein the catalyst is present in said mixture in the amount of approximately two ounces per pound of gypsum.

16. A method of preparing a construction product, comprising the steps of:
mixing together gypsum and a heat fusion catalyst which includes polyvinyl acetate and a polymer together with a chemical agent effective to maintain the polyvinyl acetate and polymer in a stable mixture; and
applying the mixed together gypsum and catalyst in fluid form to a building member.

17. A method as set forth in claim 16, including the step of mixing cement with the gypsum and catalyst.

18. A method as set forth in claim 16, including the step of mixing an aggregate material with the gypsum and catalyst.

19. A method as set forth in claim 16, wherein the catalyst is present in said mixture in the amount of approximately two ounces per pound of gypsum.
